(19) United States
(12) Patent Application Publication
(10) Pub. No.: US 2002/0134151 A1
(43) Pub. Date: Sep. 26, 2002

(54) Apparatus and method for measuring distances

(75) Inventors: Tomonobu Naruoka, Kawasaki-shi (JP); Mihoko Shimano, Tokyo (JP); Megumi Yamaoka, Tokyo (JP); Kenji Nagao, Yokohama-shi (JP)

Correspondence Address: GREENBLUM & BERNSTEIN, P.L.C., 1941 ROLAND CLARKE PLACE, RESTON, VA, 20191, US

(73) Assignee: MATSUSHITA ELECTRIC INDUSTRIAL CO., LTD., Osaka (JP)

(21) Appl. No.: 09/775,567

(22) Filed: Feb. 5, 2001

(51) Int. Cl. G06K 9/00; G01F 23/00

(52) U.S. Cl. 73/291; 382/104; 382/154; 382/106

(57) ABSTRACT

The present invention detects distances between cars through image processing. A car ahead is detected from an image taken by one camera and a relative positional relation between the detected vehicle and road edges is detected. On the other hand, a three-dimensional road structure is reconstructed from the image taken by one camera. Then, taking into account the relative positional relation in the image between the vehicle and road edges, the position of the vehicle on the reconstructed three-dimensional road structure is determined. Then, the distance from the camera to the vehicle in the real space is measured through arithmetic operations. By focusing the range of performing image processing in one image, it is possible to reduce the amount of data handled.

### BACKGROUND OF THE INVENTION

1. Field of the Invention

The present invention relates to an apparatus and method for measuring distances, and more particularly, to an apparatus and method for measuring distances that measures distances to vehicles around the own vehicle.

2. Description of the Related Art

There are conventional technologies for measuring distances such as a technology using laser radar and a technology taking stereoscopic pictures using two cameras.

The technology using laser radar requires an expensive and special apparatus. It is difficult to incorporate such an expensive and complicated apparatus in a car.

On the other hand, the method of measuring distances using two cameras requires adjustments (calibration), which increases the size of the apparatus. Thus, mounting a distance measurement apparatus on a car involves certain difficulties.

The Japanese Laid-open Patent Publication No.HEI 11-44533 discloses a system using only one camera. However, this prior art is based on the premise that the camera itself is fixed and the camera and other vehicles are located in horizontal positions.

Thus, this system cannot be said to be suited to measuring distances under circumstances where pictures of a vehicle running ahead are taken using a car-mounted camera to measure a distance between the own vehicle and the vehicle ahead, that is, circumstances where not only the target but also the camera itself is moving, and the relative positional relation between the camera and the target is changing irregularly.

The inventor of the present invention has conducted various investigations into a method of detecting positions of a vehicle driving down a road using image processing. The investigation results revealed the following:

Taking pictures of a car running ahead from another car driving down a road and applying image processing to the captured images to calculate the distance between the two cars involve considerable difficulty.

For example, accurately extracting (profiling) the area in which the car exists in itself is difficult, and therefore the reliability of the distance calculated in that way is questionable.

Moreover, in the case where distances are measured using one camera, it is a prerequisite that the own car and the target are virtually at the same height (in horizontal positions) as described above, which constitutes a considerable constraint in practical terms.

Furthermore, when three-dimensional image processing is carried out, the amount of calculation of the distance distribution for an entire screen becomes enormous, which can cause a problem of producing a processing delay. Therefore, the capacity of memory that stores distance images will increase, for example. This leads to an increase in both the hardware volume and cost of the apparatus.

The present invention has been implemented based on these considerations.

An object of the present invention is to make it possible to accurately and efficiently measure a distance from a target using one camera under circumstances where the camera itself is moving and the relative positional relation between the camera and the target is time-variable.

It is another object of the present invention to reduce the amount of data processed and reduce burden on hardware and software when the position of a vehicle driving down a road is detected through image processing.

### SUMMARY OF THE INVENTION

According to the distance measuring method of the present invention, pictures of a detection target (e.g., vehicle ahead) and pictures including road edges are taken using one camera. Then, the captured images are subjected to image processing. In this way, the existence of a target (vehicle ahead) in the image is detected and at the same time a relative positional relation between the target and road edges are determined. Likewise, a three-dimensional road structure is reconstructed through image processing on the image captured. Then, the position of a target (vehicle) on the reconstructed three-dimensional road structure is detected based on the above-described relative positional relation between the target and the ends of the road. Then, the distance between the camera and target in the real space is calculated through predetermined arithmetic operations.

That is, the present invention applies image processing to the captured image, efficiently detects the position of the target in the image and efficiently recognizes the three-dimensional structure of the road. The present invention then determines the coordinate position of the target in the real space using the positional information of the target and information on the structure of the road. Then, the present invention calculates the distance from the camera to the target. This makes it possible to accurately and efficiently calculate the distance using one camera.

A mode of the distance measuring method of the present invention first detects a target (e.g., a vehicle ahead) that exists in an image taken by one camera. Then, in the above-described image, the right and left end points (right and left edges) of the road corresponding to the position of the target detected (vehicle) are determined. In parallel with such processing, the three-dimensional road structure is detected based on the above-described image taken by one camera. Then, two points corresponding to the above-described right and left end points (right and left edges) of the road are determined. Based on the positions of these two points determined, the position of the target (vehicle) on the three-dimensional road structure is determined. Then, the distance from the camera to the target (vehicle) in the real space is determined through predetermined arithmetic operations.

Furthermore, another mode of the distance measuring method of the present invention includes the steps of storing features of a plurality of detection targets beforehand, calculating the amount of features from images input and detecting the position of the target by extracting the object most resembling the features of the detection target. The amount of features is expressed by at least one of the length, symmetry and positional relation of the linear components extracted from a differential binary image of the target.

Furthermore, in another mode of the distance measuring method of the present invention, detection of the position in the image of an object includes the step of registering a plurality of types of learning images beforehand, comparing the image input with each learning image, determining the most resembling area and thereby detecting the position of the object. For example, a set of three images is registered in a database and used as learning images, one when the object is located far from the camera, another when the object is located in a medium distance and the other when the object is located near.

Furthermore, in one mode of the distance measuring method of the present invention, the road structure recognizing method includes the steps of assuming a road model, detecting the positions of the right and left edges of the road from images input and recognizing the structure of the road plane by determining the positions of the right and left edges of the road in the real space based on the road model. The road edges are detected based on white lines normally provided at the road edges, for example.

Furthermore, a further mode of the distance measuring method of the present invention does not select the entire range of an image captured by a car-mounted camera as the target for processing of measurement of distance between cars but focuses the processing range on part of the image. This reduces the amount of data to be handled and alleviates the processing burden on the apparatus. This reserves a sufficient capacity for more sophisticated image processing operations, etc. thereafter. Focusing of the processing range is performed taking into account the structure, which is specific to the traveling path such as road edges and excluding unnecessary areas. This ensures that the vehicle ahead is captured. Focusing of the search range improves the efficiency of processing and position detection using pattern recognition, etc. allows accurate detection of vehicles. Using these synergistic effects, this embodiment provides a practical method of measuring distances between cars with great accuracy.

The distance measuring apparatus of the present invention is provided with an object detection section that detects the position in the image of an object that exists on a road from an image input from a camera, a road structure recognition section that recognizes the structure of the road plane from the image and a distance calculation section that calculates the distance from the camera to the object in the real space based on the detected object position and the road plane structure.

Furthermore, a mode of the distance measuring apparatus of the present invention is provided with a search range extraction section that focuses the search range from the image input by a car-mounted camera on the area in which the vehicle on the road exists, a vehicle position detection section that detects the position of the vehicle in the image within the search range and an inter-vehicle distance calculation section that calculates the distance in the real space between the two vehicles based on the detected position.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram showing a configuration example of a distance measuring apparatus of the present invention;

FIG. 2 illustrates an overall configuration of the apparatus in the case where the apparatus in FIG. 1 is mounted on a vehicle;

FIG. 3 illustrates an image example taken by one camera;

FIG. 4 illustrates an example of a differential binary image (a drawing to explain the method of detecting an object in the image);

FIG. 5 is a block diagram showing a configuration example of a distance measuring apparatus in the case where an object in an image is detected using a learning image;

FIG. 6 illustrates examples of learning images registered in the database shown in FIG. 5;

FIG. 7A illustrates the basic principle of a method of reconstructing a three-dimensional road shape based on corresponding points;

FIG. 7B is a drawing to explain local plane approximation;

FIG. 7C is a drawing to explain a method of determining corresponding points by local plane approximation;

FIG. 8 illustrates a relative positional relation between a target (vehicle) and road edges in an image;

FIG. 9 illustrates a positional relation of each vehicle on a three-dimensional road structure;

FIG. 10 is a drawing to explain a method of reconstructing a three-dimensional road structure by linking the shapes of local road edges determined by plane approximation;

FIG. 11A illustrates the shape of road edges sufficiently close to a camera at the present moment;

FIG. 11B illustrates the shape of road edges sufficiently close to the camera at a previous time point;

FIG. 11C illustrates a three-dimensional road structure reconstructed by linking the shape of the road edges at the previous time point and the shape of the road edges at the present moment;

FIG. 12 is a flow chart to explain a basic procedure of the distance measuring method of the present invention;

FIG. 13 is a flow chart to explain a specific procedure of an example of the distance measuring method of the present invention;

FIG. 14 is a flow chart showing an example of a specific procedure of a step of detecting the position of an object in an image in the distance measuring method shown in FIG. 12;

FIG. 15 is a flow chart showing another example of the specific procedure of the step of detecting the position of an object in an image in the distance measuring method shown in FIG. 12;

FIG. 16 is a flow chart showing an example of a specific procedure of a step of recognizing a road structure in the distance measuring method shown in FIG. 12;

FIG. 17 is a flow chart showing another example of the specific procedure of the step of recognizing the road structure in the distance measuring method shown in FIG. 12;

FIG. 18 is a block diagram showing a configuration of an inter-vehicle distance measuring apparatus of the present invention;

FIG. 19 is a flow chart showing a procedure example of a method of focusing the search range in image processing;

FIG. 20A illustrates a picture of a car ahead taken by one car-mounted camera;

FIG. 20B illustrates a picture of the car ahead taken by another car-mounted camera;

FIG. 21A is a drawing to explain white line detection processing in the processing of focusing a search range in image processing;

FIG. 21B is a drawing to explain processing to determine a search range;

FIG. 22 is a block diagram showing a specific configuration example of an apparatus to detect the position of a vehicle in an image;

FIG. 23 is a drawing to explain an example of a distance calculation method of the present invention;

FIG. 24 illustrates the correspondence between an image plane and a real space; and

FIG. 25 illustrates a configuration example of the inter-vehicle distance measuring apparatus of the present invention using two cameras.

### DETAILED DESCRIPTION OF THE PREFERRED EMBODIMENTS

(Embodiment 1)

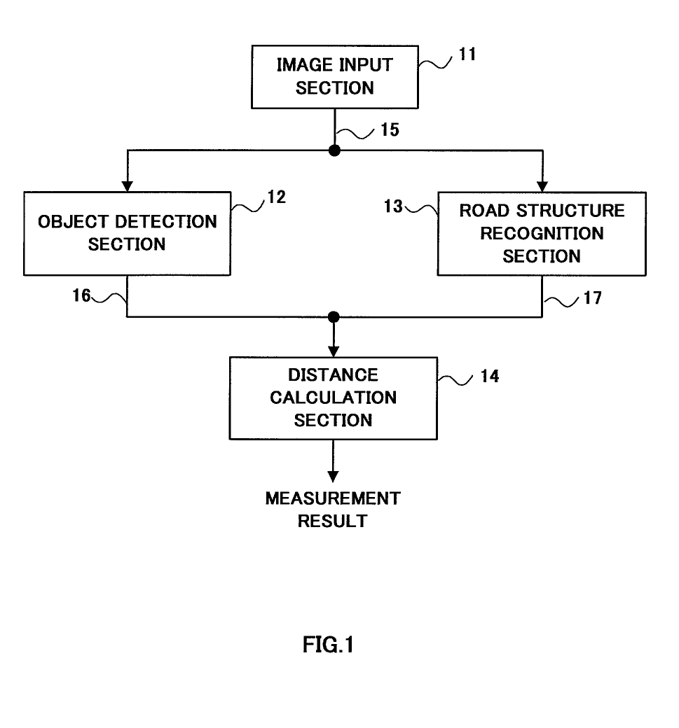

Embodiment 1 of the present invention will be explained below with reference to FIG. 1 to FIG. 17.

FIG. 1 is a block diagram of a distance measuring apparatus of this embodiment.

This embodiment detects an object from an image taken by one camera and detects a relative positional relation between the object and road edges.

This embodiment reconstructs a three-dimensional road structure from the shapes of the road edges in the image and then identifies the coordinates of the object (position of the object in the real space) on the reconstructed three-dimensional road structure taking into account the relative positional relation between the object and road edges.

Then, this embodiment detects the distance from the camera to the object through predetermined arithmetic operations.

In FIG. 1, image input section 11 is configured by one camera and an input interface circuit.

Object detection section 12 extracts the area of the object based on image data 15 entered and outputs information 16 indicating the position of the object. Road structure recognition section 13 recognizes the road structure based on image data 15 entered and outputs road structure information 17.

Distance calculation section 14 calculates the distance from the camera to the object using position information 16 and road structure information 17 and outputs measurement result 18.

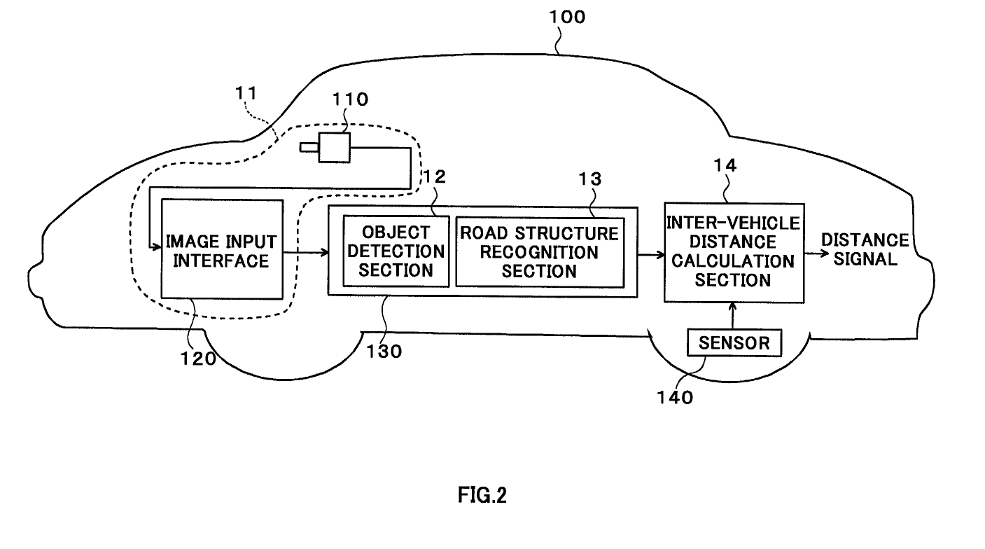

FIG. 2 illustrates the configuration in the case where the distance measuring apparatus shown in FIG. 1 is mounted on a vehicle. In the case of the configuration shown in FIG. 2, the distance measuring apparatus is used to measure distances between cars.

As illustrated, image input section 11 mounted on vehicle 100 is provided with one camera 110 and image input section 120. Image processing section 130 is provided with object detection section 12 and road structure recognition section 13.

Inter-vehicle distance calculation section 14 is supplied with information on the car speed, traveling distance and the rotation angle of the vehicle from sensor 140 when required.

Next, the content of image processing will be explained.

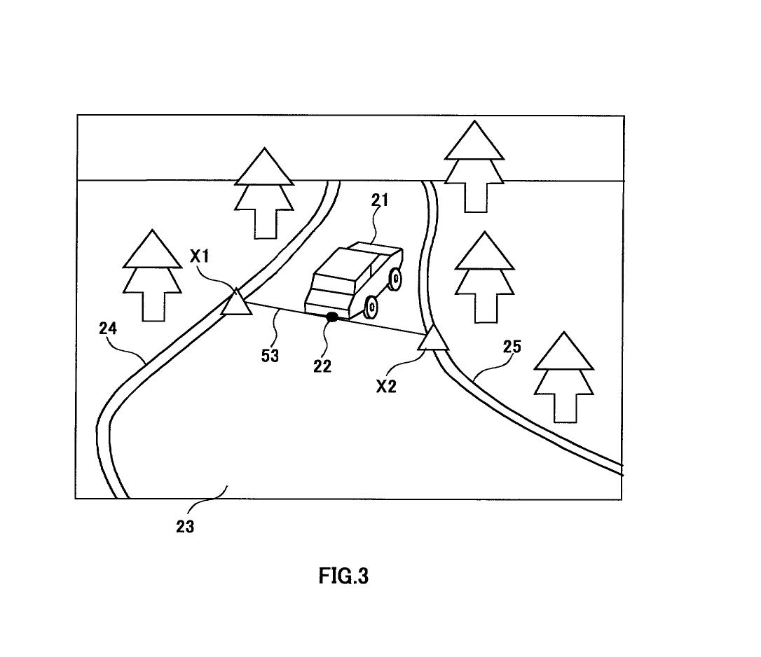

FIG. 3 shows an image example (image data 15 in FIG. 1) taken by one camera (reference numeral 110 in FIG. 2).

As illustrated, vehicle 21, a detection target, is located on road 23.

White lines 24 and 25 are drawn on the right and left of road 23.

Object detection section 12 in FIG. 1 detects vehicle 21, a detection target, based on image data 15 as shown in FIG. 3 entered by image input section 11. Object detection section 12 then identifies the position of the vehicle in the image and outputs its position information 16 to distance calculation section 14.

An example of a system of detecting the position of an object from an image is described in the Technical report of Information Processing Society of Japan CV37-4 (1985) “An Automatic Identification and Tracking of a Preceding Car”.

This system assumes a vehicle running ahead as a detection target and the following gives a brief explanation thereof.

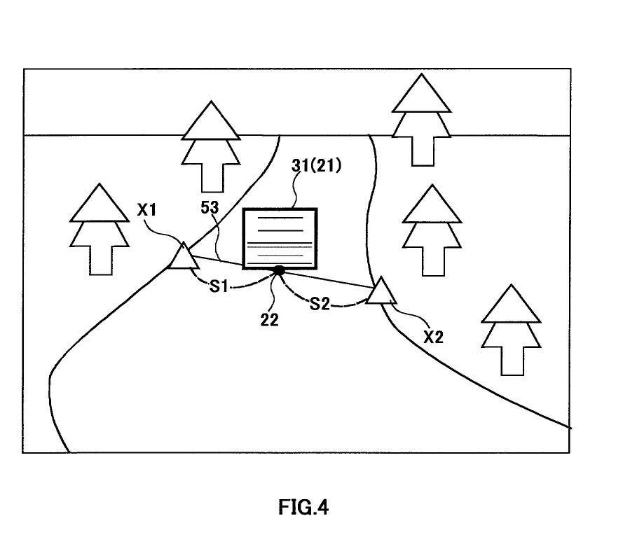

First, secondary differential processing and binary processing are applied to an input image of the rear face of the vehicle ahead. This gives a differential binary image as shown in FIG. 4. Then, horizontal edge components are extracted from the image obtained and this set of components is used as a model of the car ahead.

Rectangular box 31 shown at the center of FIG. 4 represents the model of the car ahead, a detection target.

That is, the shape of vehicle 21 viewed from behind is a roughly symmetric box and includes many horizontal components such as the roof and window frames.

Therefore, when the image taken by one camera is subjected to differential processing and the characteristic shape is extracted, it possible to detect a model of the vehicle ahead as shown in FIG. 4 in the shape of a symmetric box with many horizontal components.

Thus, it is possible to efficiently detect a vehicle ahead by extracting linear components from a differential binary image and based on at least one of the length, symmetry and positional relation between the extracted straight lines of these linear components.

Furthermore, the positions of the road edges can be easily identified by recognizing the positions of the right and left white lines as the edges of the road, for example. Even if the white lines are interrupted, it is possible to determine the road edges by complementing the white lines through curve complementing or linear complementing.

The position of the detected vehicle in the image can be expressed in coordinates of the points representing the vehicle. For example, suppose the midpoint of the lower side of the rectangular box in FIG. 4 (reference numeral 22) is the position of the vehicle ahead.

Furthermore, the position of the vehicle can be determined in association with the road edges as shown in FIG. 3 and FIG. 4.

That is, from among an infinite number of line segments connecting the right and left edges of the road and passing coordinate point 22 of the vehicle, the shortest line segment (reference numeral 53 in FIG. 3 and FIG. 4) is selected.

The two points at which the selected line segment 53 intersects with the road edges are assumed to be x1 and x2. As shown in FIG. 4, when distances S1 and S2 from points x1 and x2 to coordinate point 22 of the vehicle are obtained, the relative positional relation between the road and vehicle is uniquely determined.

An example of the processing of identifying the vehicle ahead and detecting the position thereof has been explained above.

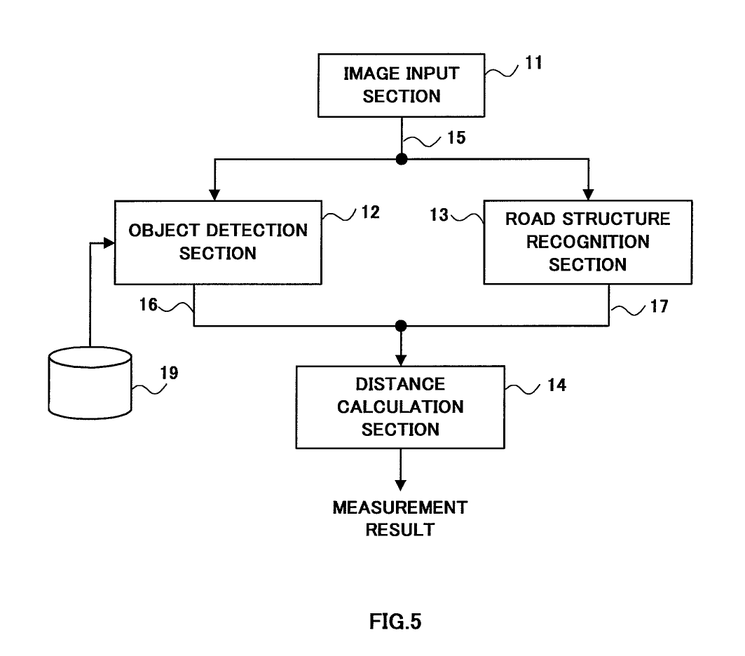

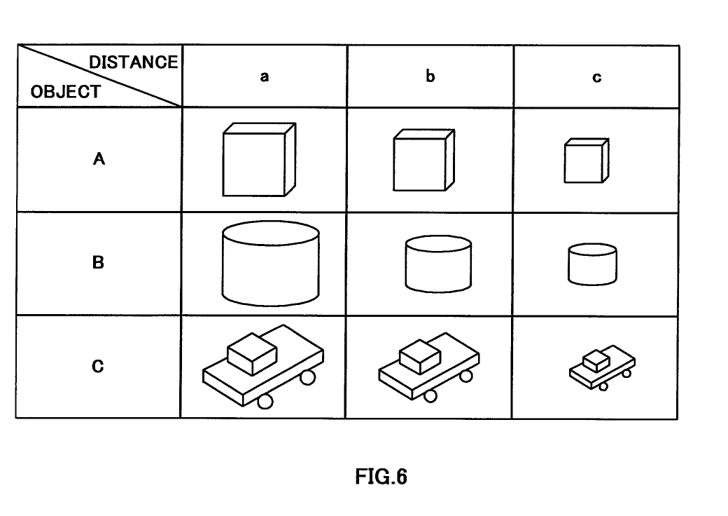

FIG. 5 and FIG. 6 are drawings to explain another example of the processing of identifying the vehicle ahead.

The configuration of the distance measuring apparatus in FIG. 5 is almost the same as the configuration of the apparatus in FIG. 1, but differs in that the distance measuring apparatus in FIG. 5 is provided with database 19 that stores learning images.

Database 19 registers a plurality of learning images as shown in FIG. 6.

The images in FIG. 6 are configured by object A (rectangular parallelepiped), object B (cylinder) and object C (vehicle), each consisting of images of large, medium and small sizes.

That is, pictures of objects located at distance “a” from the camera are taken by the camera, then pictures of objects located at distance “b” from the camera are taken by the camera and pictures of further objects located at distance “c” from the camera are taken by the camera. Here, suppose a<b<c.

A plurality of images acquired by this picture taking is registered in database 19, which clarifies relations with different objects as shown in FIG. 6. That is, images of one object in sizes varying depending on the distance from the camera are registered.

When image data 15 is input, object detection section 12 in FIG. 5 compares image data 15 with data of learning images registered in database 19.

Object detection section 12 then detects the most resembling learning image and at the same time acquires the information (position information of the object) to identify the area in the input image most resembling the detected learning image.

The detection system for detecting an object using learning images can detect the position of the object only through pattern matching between the input image and learning image, thus simplifying the position detection processing.

Furthermore, it is also possible to automatically calculate a rough distance from the camera to the object by examining which of distance “a”, “b” and “c” the detected learning image corresponds to.

The information on the rough distance from the camera to the object allows distance calculation section 14 to carry out distance measuring processing efficiently.

Detection of an object (vehicle) and detection of the position of the object have been explained above.

Next, detection of the three-dimensional road structure will be explained below.

Road structure recognition section 13 in FIG. 1 (FIG. 2) recognizes the structure in the real space of road 23 based on image data 15 shown in FIG. 3 input by image input section 11.

An example of a system of recognizing the structure of the road plane in the real space from an image without depth information (image taken by one camera) is disclosed in the information processing research report CV62-3 (1989) “Road Shape Reconstruction by Local Flatness Approximation”.

This system focuses on points corresponding to the right and left road edges in an image and determines a three-dimensional road structure based on knowledge on the road shape called a “road model”.

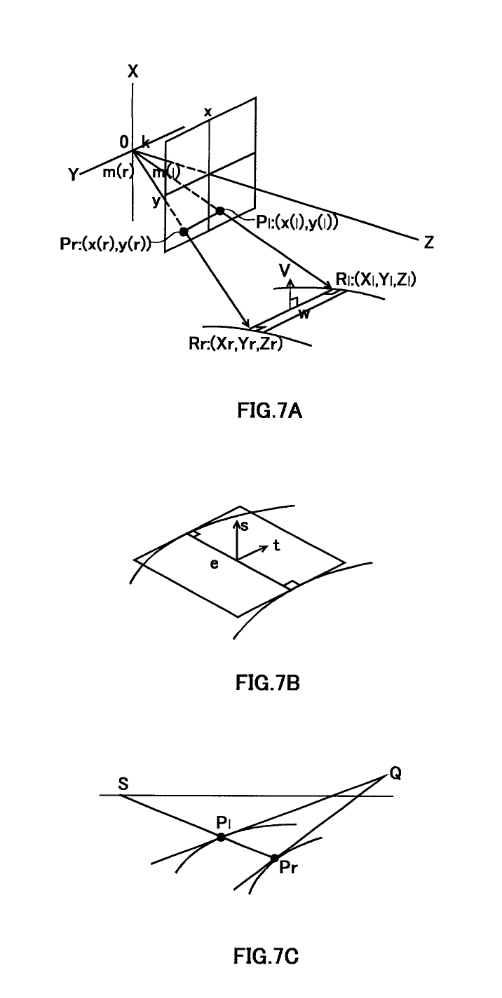

This method of reconstructing the road structure will be briefly explained below with reference to FIG. 7A to FIG. 7C.

In FIG. 7A, the origin of coordinates “0” denotes the position of a camera. m(l) is a vector defined based on the left edge point of the road. m(r) is a vector defined based on the right edge point of the road. Coordinate points Pl and Pr denote the left end point and right end point, respectively on a same line of the road in the image taken by one camera. Coordinate points Rl and Rr denote the left end point and right end point of the road, respectively on the road in the real space.

By multiplying the left end point and right end point (P1, Pr) of the road in the image by a predetermined vector arithmetic coefficient, it is possible to determine the corresponding coordinate points (Rl, Rr) on the road in the real space. The loci of the determined coordinate points Rl and Rr form the shapes of the edges of the road.

That is, the three-dimensional shapes of the road edges are assumed to be the loci drawn by both end points of a virtual line segment connecting the left end point and right end point of the road when the line segment moves on a smooth curve.

Though the actual road has a certain gradient, from a local point of view as shown in FIG. 7B, the tangent (t) on the road plane and the virtual line segment (e) can be considered to be included in a same plane (local plane approximation).

Moreover, as shown in FIG. 7C, when a condition that the point at infinity (Q) in the tangential direction of the road is on the horizontal line and the line segment (Pl-Pr) crosses the edge of the road at right angles is applied, the two corresponding points on the two-dimensional road can be calculated through vector operations.

The shape of the road is reconstructed by applying a road model so that a three-dimensional variation of the positions of the calculated right and left edges of the road becomes a smooth curve.

The road model is constructed under conditions that the distance between the right and left edges of the road a is constant and any line segment connecting these edges is always horizontal.

This is an outline of the method of reconstructing the shape of the road disclosed in “Reconstruction of Road Shape by Local Plane Approximation”.

Then, the processing of detecting the distance from the own vehicle to the vehicle ahead by distance calculation section 14 in FIG. 1 (FIG. 2) will be explained.

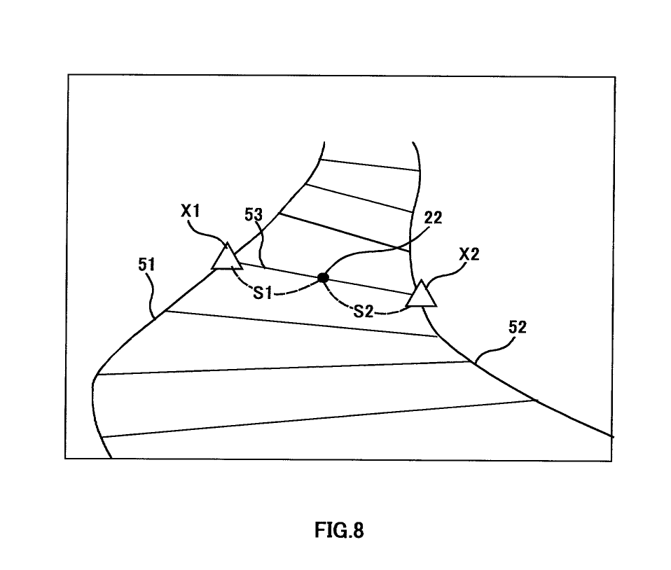

FIG. 8 illustrates a relative positional relation between a vehicle ahead (detection target) in an image taken by one camera and the edges of the road.

As explained above using FIG. 4, the position of the vehicle and the positions of the right and left edges of the road corresponding to the vehicle are already identified.

That is, as shown in FIG. 8, coordinate point 22 located almost at the center of the road indicates the position of the vehicle ahead.

The shortest line segment passing coordinate point 22 is line segment 53. Here, it is also possible to determine line segment 53 in such a way as to have a predetermined length.

The points at which line segment 53 crosses edges 51 and 52 of the road are x1 and x2 (edge points).

Thus, in one image taken by one camera, the position of the vehicle and the relative positional relation between the vehicle and the edges of the road are identified.

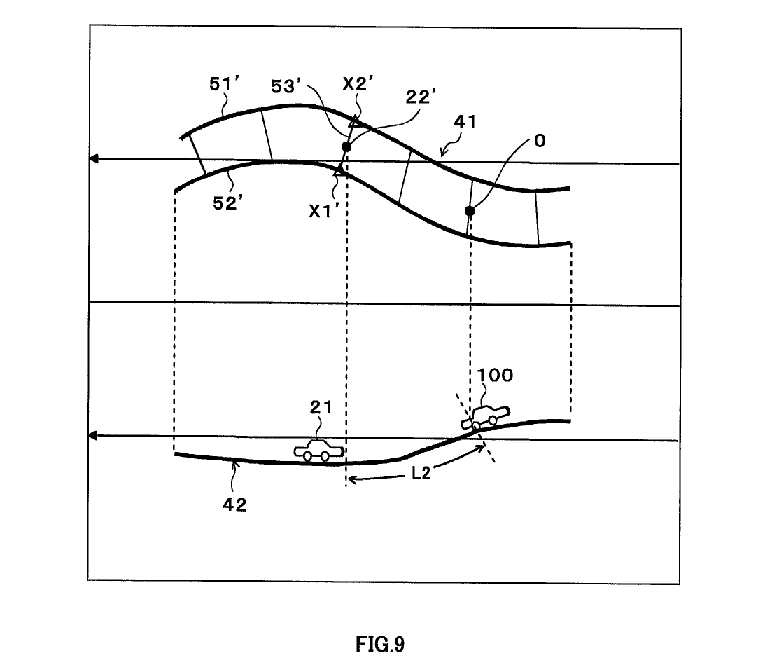

Then, the three-dimensional road structure is reconstructed using the method shown in FIG. 7A to FIG. 7C. The reconstructed road structure is shown in FIG. 9.

Once the position of the vehicle ahead on the reconstructed three-dimensional road structure is known, the distance from the camera to the vehicle in the real space can be calculated through simple arithmetic operations (geometric operations).

Reference numeral 41 in FIG. 9 denotes a top view of the shape of the road. On the other hand, reference numeral 42 denotes a side view of the shape of the road plane.

As shown in FIG. 7A, the right and left edges of the road in one image have a one-to-one correspondence with the right and left edges of the road on the three-dimensional road structure.

That is, it is possible to determine the points on the reconstructed road structure shown in FIG. 9 that correspond to the right and left edges of road edge points x1 and x2 in the image of FIG. 8.

In FIG. 9, point x1′ corresponds to point x1 in FIG. 8. Likewise, point x2′ corresponds to point x2 in FIG. 8. Thus, once the end points of the road (x1′, x2′) in the real space are determined, line segment 53′ connecting these end points is determined.

The vehicle ahead is located on line segment 53′ in the real space. As shown in FIG. 4 and FIG. 8, the vehicle in the image is located at distance S1 from point x1 and at distance S2 from point x2.

Position 22′ of the vehicle on line segment 53′ in FIG. 9 is determined from such a relative positional relation between the vehicle and road.

Once position 22′ of the vehicle in the three-dimensional space is detected, it is possible to determine the distance from the coordinates (origin O) of the camera mounted on own vehicle 100 to vehicle 21 through simple arithmetic operations.

In this way, it is possible to determine the three-dimensional shape of the road as shown in FIG. 9 and the three-dimensional position of the vehicle on the road from the image as shown in FIG. 8. Then, it is possible to measure the distance from the camera to the vehicle ahead in the real space.

In the above explanations, the three-dimensional structure of the road is determined using the method shown in FIG. 7A to FIG. 7C, but this embodiment is not limited to this.

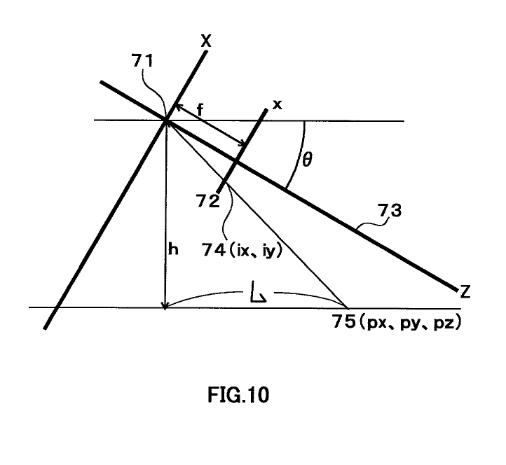

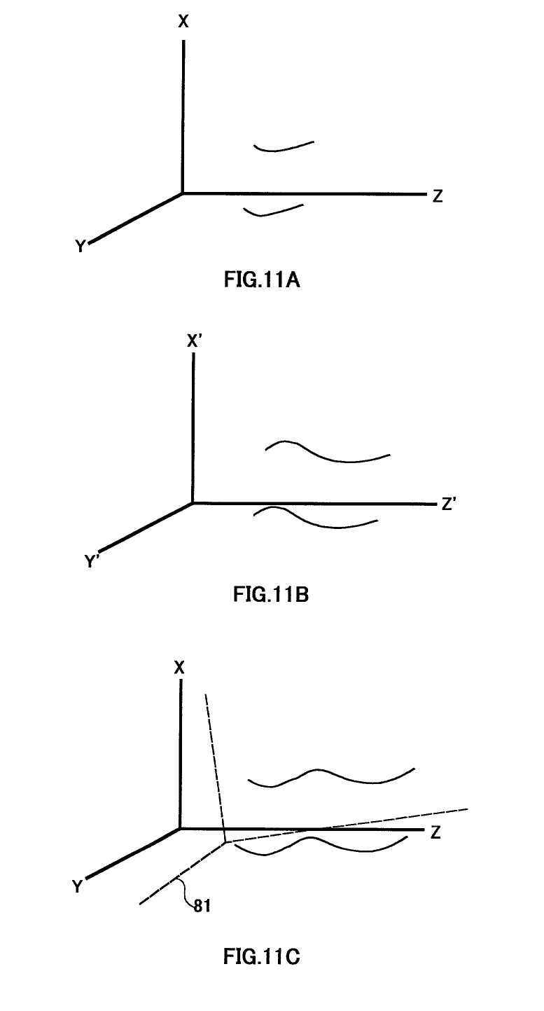

Another method of detecting the three-dimensional structure of the road will be explained using FIG. 10 and FIG. 11A to FIG. 11C.

Assuming that the road is flat from a local point of view, this method takes pictures of the road edges very close thereto by one camera and measures the distance from the camera to the road edges. This method then applies a smooth curve to the points of the determined road edges and reproduces a local shape of the road.

This method then reconstructs the overall shape of the road by connecting the reproduced local shapes of the road while shifting these local shapes taking into account the amount of movement of the own vehicle.

This will be explained more specifically below.

FIG. 10 shows a configuration of an apparatus to measure distance L on a horizontal plane.

In FIG. 10, reference numeral 73 denotes the center of a lens, reference numeral 72 denotes the coordinate axis of an image, reference numeral 73 denotes the coordinate axis in the real space, reference numeral 74 denotes a position in the image and reference numeral 75 denotes a position in the real space. However, in both cases, the y-axis is assumed to be the direction perpendicular to the surface of this sheet.

FIG. 11A, 11B and 11C show the road structure in the real space.

FIG. 11A shows the actual road structure at a position sufficiently close to the camera at the present moment, FIG. 11B shows a recognition result of the road structure at a previous time point. FIG. 11C shows a state in which one road structure has been determined by connecting the road structure recognized at the previous time point and the road structure recognized at the present moment. Reference numeral 81 denotes the coordinate axis at the previous time point.

In the following explanations, suppose the camera is set at the rear of the own car, consecutively taking pictures in the direction opposite to the direction in which the own car is headed and the road is horizontal at locations sufficiently close to the camera.

First, the coordinates (ix, iy) of the position of the white line in the image are detected at locations sufficiently close to the camera.

As shown in FIG. 10, suppose the focal distance is f, the height of the center of the lens is h, the angle of the optical axis of the camera from the horizontal direction is ë. Then, based on the above supposition, the position (px, py, pz) of the white line in the real space is expressed in the following (mathematical expression 1).

$$\begin{matrix}px = \frac{h \cdot ix}{f \cdot sin θ - ix \cdot cos θ} \\ py = \frac{h \cdot iy}{f \cdot sin θ - ix \cdot cos θ} \\ pz = \frac{h \cdot f}{f \cdot sin θ - ix \cdot cos θ}\end{matrix} \} \qquad ( Mathematical expression 1 )$$

Calculating the positions of the white lines in the real space from all the detected positions of the white lines within the range in the image sufficiently close to the camera and then applying a smooth curve to these positions will make it possible to obtain a road structure in the real space at locations sufficiently close to the camera as shown in FIG. 11A.

Here, suppose the road structure in the real space as shown in FIG. 11B was output on the coordinate axes at the previous time point.

Furthermore, the amount of movement of the vehicle itself from the previous time point to the present moment, that is, the amount of movement of translation from the coordinate axes at the previous time point to the coordinate axes at the present moment and information of the rotation angle are acquired through various sensors (reference numeral 140 in FIG. 2) mounted on the vehicle.

Then, the road structure at the location sufficiently close to the camera shown in FIG. 11A determined at the present moment is connected with the road structure at the previous time point shown in FIG. 11B taking into account the above-described amount of movement. This reconstructs the road structure as shown in FIG. 11C.

The processing of detecting the position of a vehicle, detecting a relative relation between the vehicle and the road and calculating the distance to a vehicle ahead according to the present invention has been explained so far.

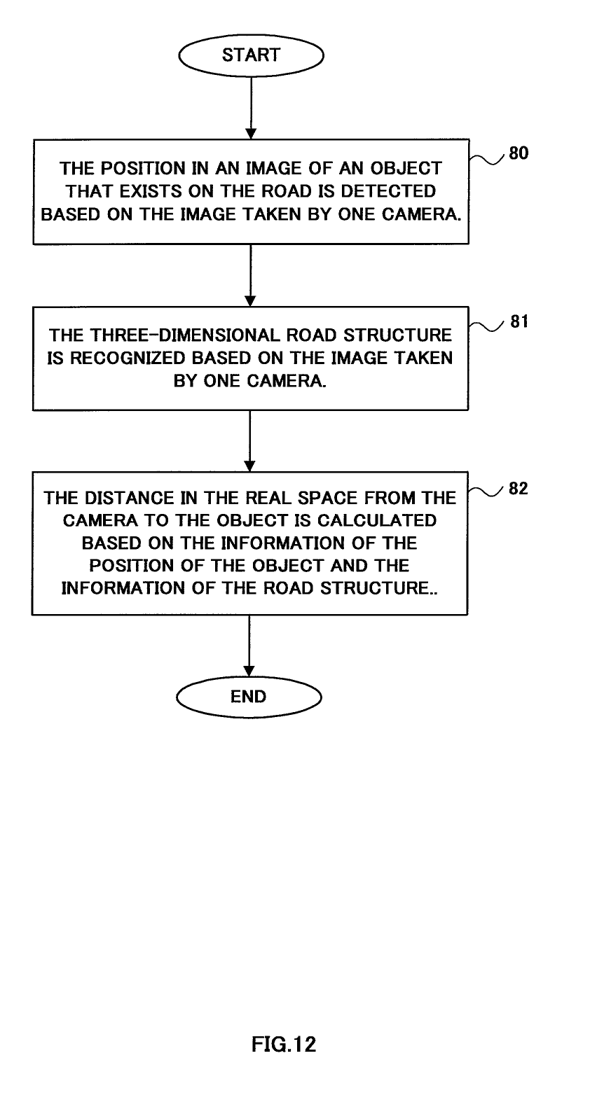

The processing of distance detection in the present invention is summarized as shown in FIG. 12.

That is, the position in an image of an object that exists on the road is detected based on the image taken by one camera first (step 80).

Then, the road structure is recognized based on the image taken by one camera (step 81).

Then, the distance in the real space from the camera to the object is calculated based on the information of the position of the object and the information of the road structure (step 82).

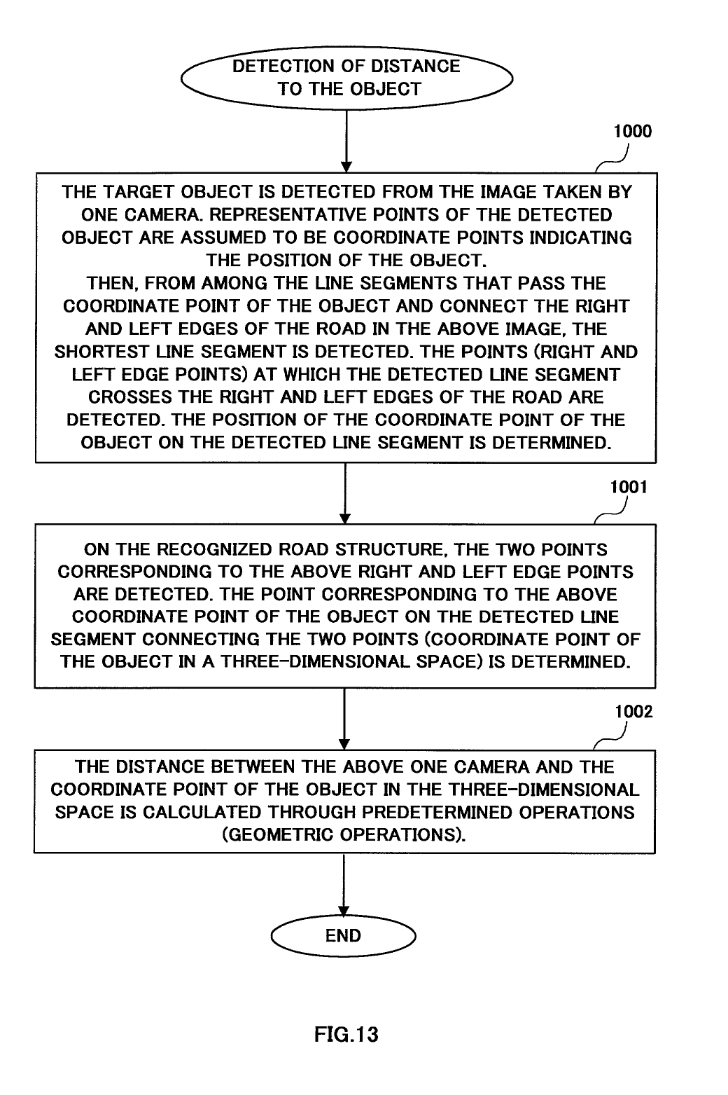

A more specific description of the processing is given in FIG. 13.

That is, the target object is detected from the image taken by one camera first. Suppose representative points of the detected object are coordinate points indicating the position of the object. Then, from among the line segments that pass the coordinate point of the object and connect the right and left edges of the road in the above image, the shortest line segment is detected. The points (edge points) at which the detected line segment crosses the right and left edges of the road are detected. The position of the coordinate point of the object on the detected line segment is determined (step 1000) .

Then, on the recognized road structure, the two points corresponding to the above edge points are detected. The point corresponding to the above coordinate point of the object on the line segment connecting the detected two points (coordinate point of the object in a three-dimensional space) is determined (step 1001).

The distance between the above one camera and the coordinate point of the object in the three-dimensional space is calculated through predetermined operations (geometric operations) (step 1002).

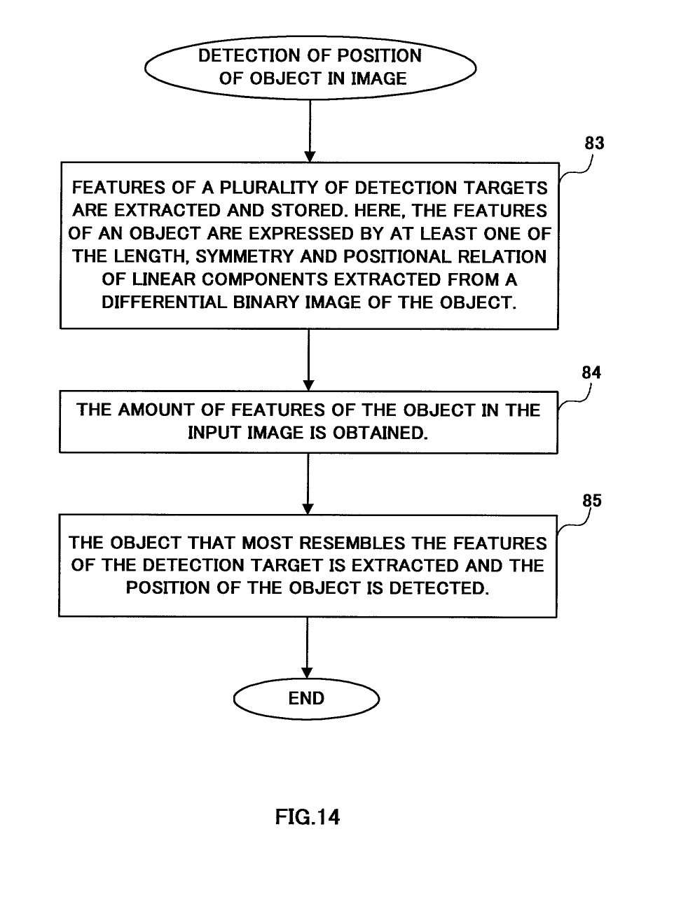

Furthermore, detection of the position of the object in the image in step 80 in FIG. 12 is carried out as shown in FIG. 14, for example.

That is, features of a plurality of detection targets are extracted and stored (step 83). Here, the features of a target object are expressed by at least one of the length, symmetry and positional relation of linear components extracted from a differential binary image of the object.

Then, the amount of features of the object in the input image is obtained (step 84).

Then, the object that most resembles the features of the detection target is extracted and the position of the object is detected (step 85).

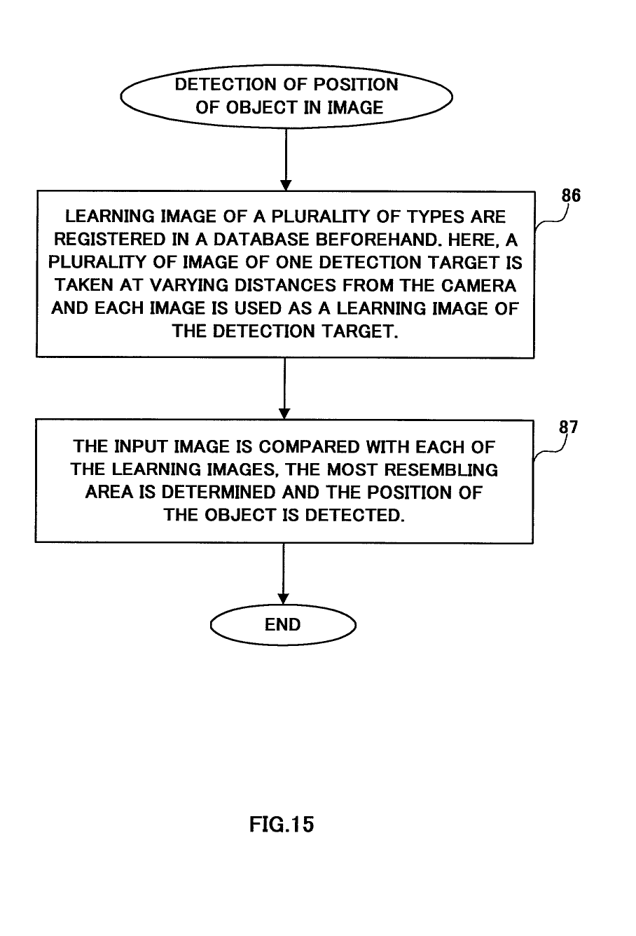

Furthermore, detection of the position of the object in the image in step 80 in FIG. 12 can also be implemented using the procedure shown in FIG. 15.

That is, learning images of a plurality of types are registered in a database beforehand (step 86). Here, for one detection target, a plurality of images at varying distances from the camera is taken and a set of these images is used as the learning images of the detection target.

Then, the input image is compared with each of the learning images, the most resembling area is determined and the position of the object is detected (step 87).

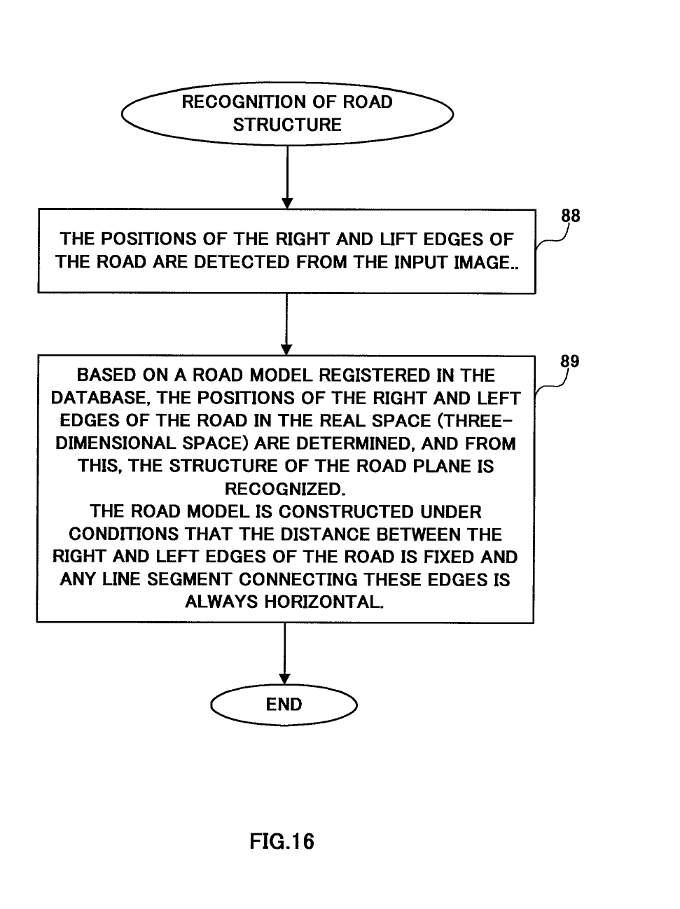

The road structure in step 81 in FIG. 12 is recognized using the procedure shown in FIG. 16, for example.

That is, the positions of the right and left edges of the road are detected from the input image (step 88).

Then, based on a road model registered in the database, the detected positions of the right and left edges of the road in the real space are determined, and from this the structure of the road plane is recognized (step 89). Here, the road model is constructed under conditions that, for example, the distance between the right and left edges of the road is fixed and any line segment connecting these edges is always horizontal.

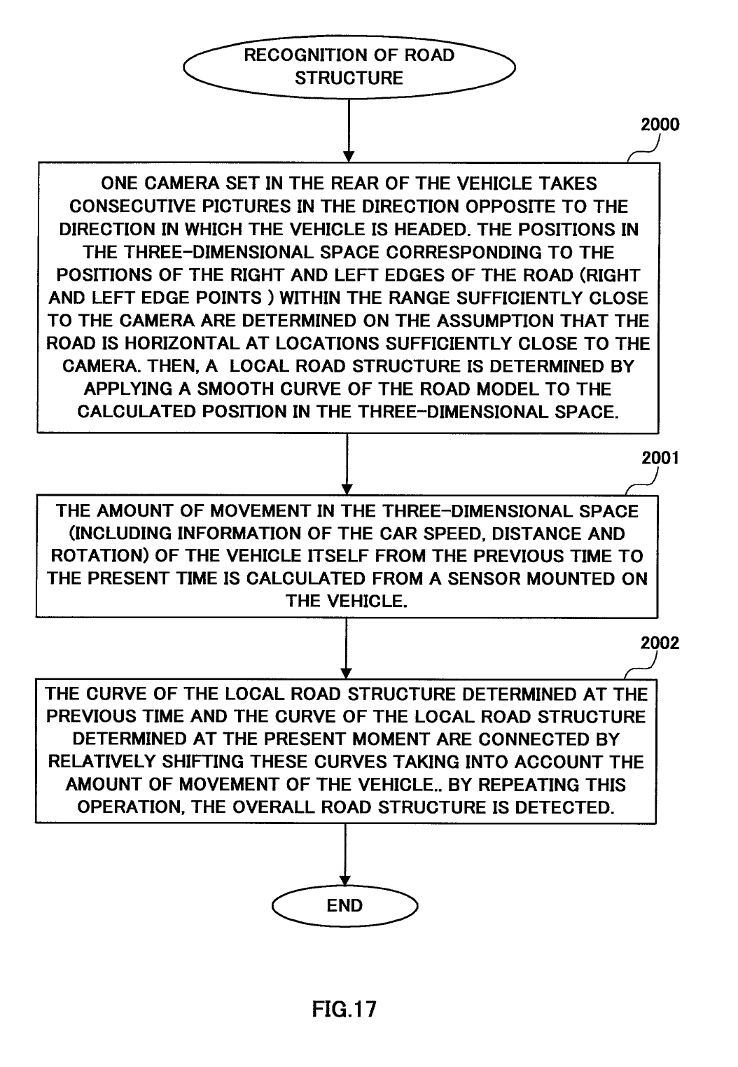

Furthermore, the three-dimensional road structure can also be detected using the method shown in FIG. 17.

That is, one camera set in the rear of the vehicle takes consecutive pictures in the direction opposite to the direction in which the vehicle is headed. The positions in the three-dimensional space corresponding to the positions of the right and left edges of the road (right and left edge points) within the range sufficiently close to the camera are determined on the assumption that the road is horizontal at locations sufficiently close to the camera. Then, a local road structure is determined by applying a smooth curve of the road model to the calculated position in the three-dimensional space (step 2000).

Then, the amount of movement in the three-dimensional space (including information of the car speed, distance and rotation) of the vehicle itself from the previous time to the present time is calculated from a sensor mounted on the vehicle (step 2001).

Then, the curve of the local road structure determined at the previous time and the curve of the local road structure determined at the present time are connected by relatively shifting these curves taking into account the amount of movement of the vehicle. By repeating this operation, the overall road structure is detected (step 2002).

(Embodiment 2)

Then, Embodiment 2 of the present invention will be explained.

In this embodiment, the number of cameras that take pictures of a target is not limited to one. In this embodiment, the most important theme is to reduce the amount of data subject to image processing.

This embodiment focuses a search range on the area in which a vehicle exists from an image input from a car-mounted camera, detects the position of the vehicle in the image within the search range and calculates the distance to the vehicle in the real space based on the detected position. Since this embodiment performs accurate distance detection processing after focusing the search range, this embodiment can attain both high efficiency and high detection accuracy.

This embodiment further detects road edges and focuses the search range taking into account the detected positions of the road edges and height of the vehicle. As a preferred example, an area obtained by expanding a segment between the road edges by an amount that takes into account the height of the vehicle is approximated with a rectangle and the coordinates of its vertices are used as information of the search range. This allows effective and efficient focusing of the search range.

This embodiment further makes it possible to adjust the degree of focusing of the search range by parameter specification. This is to allow the search range to be expanded or contracted at any time according to the surrounding situation when the car is running and required detection accuracy, etc.

Furthermore, this embodiment determines the area on the road in which the vehicle exists through an optical flow method and uses this as the search range.

Furthermore, this embodiment determines the area on the road in which the vehicle surface exists using a stereoscopic image and uses this as the search range.

Furthermore, this embodiment combines the area on the road in which the vehicle exists determined through the optical flow method and the area on the road plane in which the vehicle exists determined using the stereoscopic image and uses this as the search range. This focuses the search range according to the movement of the target and recognition, etc. of a three-dimensional image.

Furthermore, this embodiment registers a vehicle model beforehand to detect the position of the vehicle in the image and designates the position with the maximum similarity between the target and the vehicle model within the search range as the position of the vehicle in the image. This performs matching with the registered model to determine the position of the vehicle. This allows accurate position determination.

Furthermore, this embodiment calculates the distance to the vehicle in the real space using a stereoscopic image based on the detected position of the vehicle.

Furthermore, this embodiment calculates the distance to the vehicle in the real space using the detected position of the vehicle in the image and the two-dimensional shape of the road.

Furthermore, this embodiment calculates the distance to the vehicle in the real space using laser radar based on the detected position of the vehicle in the image. Since the position of the target (vehicle) in the image is identified, it is possible to efficiently calculate the distance to the vehicle in the real space.

Furthermore, the inter-vehicle distance measuring apparatus of this embodiment is provided with a vehicle position detection section and a search range extraction section. This search range extraction section is provided with a regulation section to regulate the degree of focusing of the search range through parameter specification. The vehicle position detection section examines the similarity between a registered vehicle model and a target within the above search range, and it is desirable to regard the position with the maximum similarity as the position of the vehicle.

This implements a practical inter-vehicle distance detection apparatus capable of detecting vehicles efficiently and accurately and detecting distances between vehicles accurately.

This embodiment will be explained more specifically using the attached drawings below.

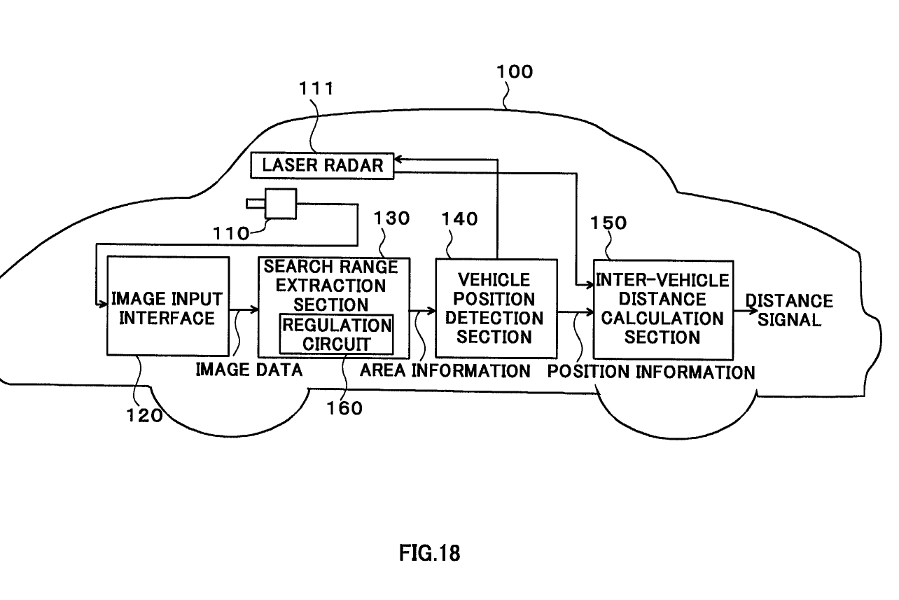

FIG. 18 is a block diagram showing a configuration of the inter-vehicle distance detection apparatus.

As illustrated, this inter-vehicle distance detection apparatus is provided with camera (car-mounted camera) 110 mounted on vehicle 100, image input interface 120, search range extraction section 130 with built-in regulation circuit 160, vehicle position detection section 140 and inter-vehicle distance calculation section 150.

In this embodiment, the number of car-mounted cameras 110 is not limited to 1.

Image input interface 120 is fed an image signal captured by car-mounted camera 110.

Search range extraction section 130 focuses the search range in search for an area on the road in which a vehicle is likely to exist based on the image data entered.

Regulation circuit 160 built in this search range extraction section 130 functions to regulate the degree of focusing of the search range according to parameter specification. For example, the regulation circuit 160 widens the search range according to the situation to prevent detection leakage or on the contrary, narrows the search range for securer and more efficient detection, etc.

On the other hand, vehicle position detection section 140 detects the position of the vehicle in the image within the search range based on the area information acquired by search range extraction section 130.

Inter-vehicle distance calculation section 150 calculates the distance to the vehicle in the real space based on the position information calculated by vehicle position detection section 140 and outputs the measurement result.

Operation of each section (function of each section) of the inter-vehicle distance measuring apparatus in the above configuration will be explained below. What is of particular importance here is the operation of search range extraction section 130.

Focusing of the search range is the processing to determine from the entire image range a range in which it is estimated that there is an extremely high probability that the car ahead (or car behind) will exist.

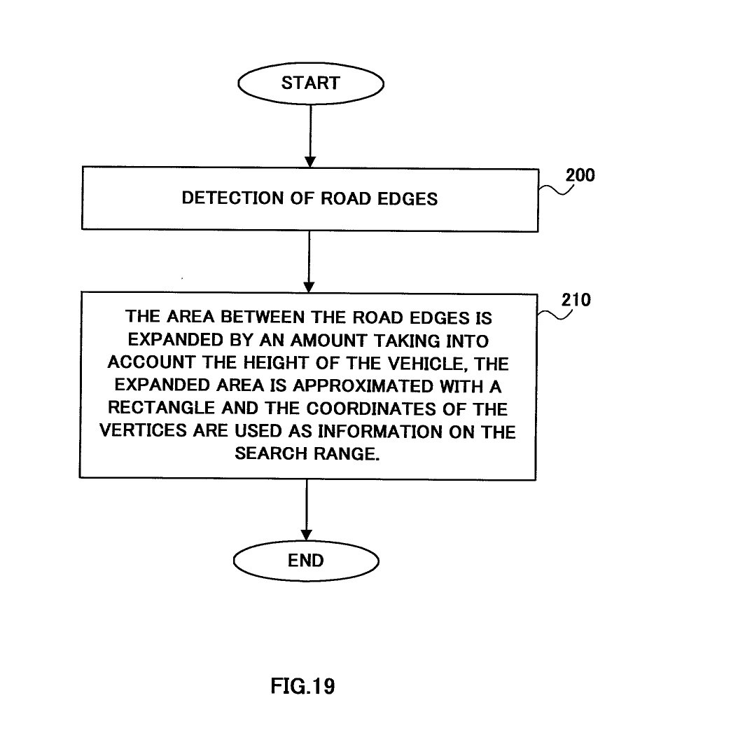

An example of desirable focusing of the search range in this embodiment is shown in FIG. 19.

As illustrated, the road edges (white lines and shoulders, etc. on both sides of the road) are detected (step 200).

Then, the area between the road edges is expanded by an amount taking into account the height of the vehicle, the expanded area is approximated with a rectangle and the coordinates of the vertices are used as information on the search range (step 210).

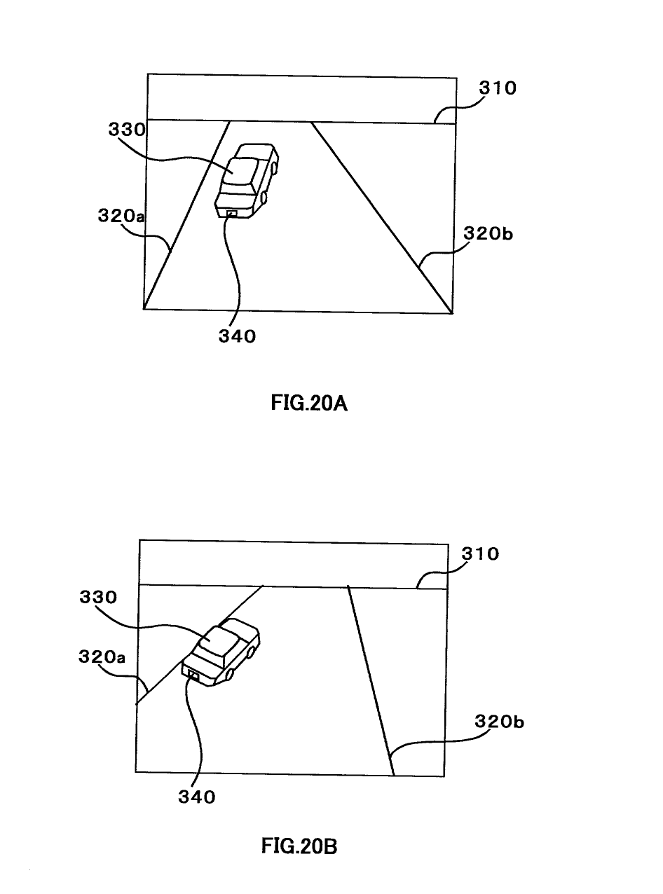

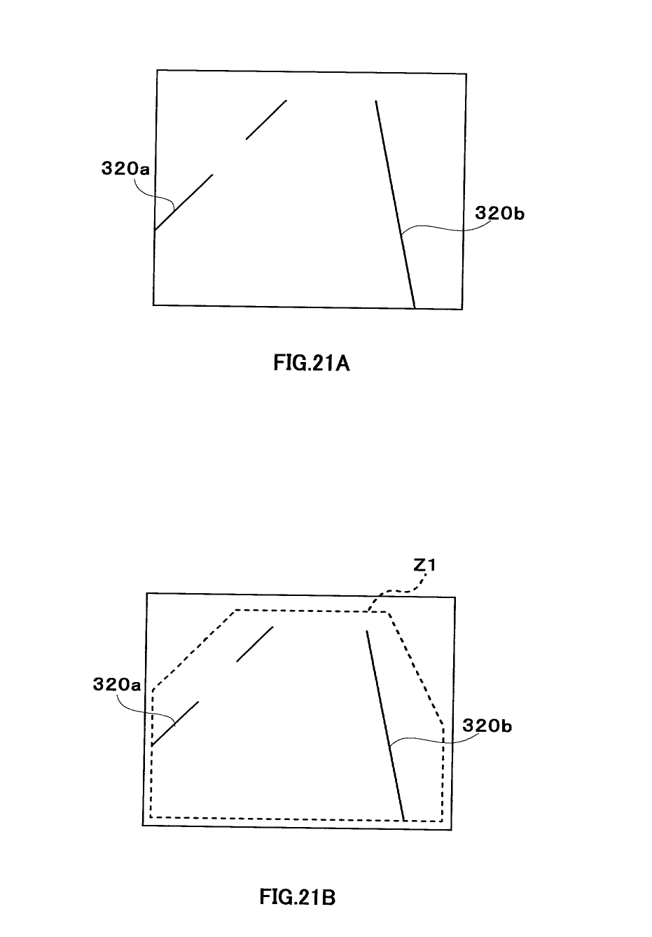

This processing will be explained more specifically using FIG. 20A, 20B, FIG. 21A and 21B below.

FIG. 20A and FIG. 20B show image examples taken by camera 110 in FIG. 18. FIG. 20A and FIG. 20B each show images of a same vehicle taken by different cameras.

That is, these are the images of a car running ahead of the own car taken by a plurality of cameras mounted on the own car. Based on this image data, search range extraction section 130 in FIG. 18 focuses the search range.

Reference numeral 310 in FIG. 20A and FIG. 20B denotes a horizontal line and reference numerals 320a and 320b denote white lines indicating the road edges. Reference numeral 330 denotes a car (car ahead), a detection target, and reference 340 denotes a number plate.

First, the white lines on both sides of the road are detected from the image in FIG. 20A (detection of road edges, step 200 in FIG. 19).

FIG. 21A shows a state in which the white lines have been detected in this way. At this time, if some sections are not detected, these sections are complemented using a curve approximation, etc. from the detected white lines.

Then, as shown in FIG. 21B, the area between the right and left white lines expanded by an amount taking into account the height of the vehicle is approximated with a rectangle (step 200 in FIG. 19).

The area determined in this way is search range Z1 indicated by an area enclosed by dotted line in FIG. 21B. As described above, how much the area is to be expanded is adjustable by regulation circuit 160.

That is, since the car ahead is running on the road without doubt, the car must be found between white lines 320a and 320b at both ends. Moreover, since the car has a certain height, white lines 320a and 320b are translated upward taking into account this fact and the height is regulated within the range that covers the entire car ahead.

Area Z1 is determined in this way. The information of the vertices of this area is sent to vehicle position detection section 140 in FIG. 1.

Compared to the case where the entire screen becomes the search target, this embodiment reduces image data to be searched by the amount corresponding to the focusing and reduces burden on vehicle position detection section 140 and inter-vehicle distance calculation section 150.

This can also provide sufficient leeway in terms of processing time. Moreover, the method of focusing the search range taking into account the road edges and height of the car is simple and has a high probability of securely capturing the vehicle.

This embodiment, however, is not limited to this method, but other focusing methods can also be applied.

For example, an optical flow method can be used. Detection of a vehicle area using the optical flow method is disclosed, for example, in the paper “Rear-side observation of Vehicle Using Sequence of Road Images” (Miyaoka, et al., Collected Papers of 4th Symposium on Sensing via Image Information (SII′98), pp.351-354).

That is, two consecutively taken images are prepared. Then, the location in the second image of a specific area of the first image is examined. Then, the vector connecting the specific area in the first image and the specific area in the second image is used as an optical flow. Then, based on the position of the optical flow in the coordinate system, the position of the vehicle is identified.

That is, when both the own car and car ahead are assumed to be moving, the car ahead and road appear to be moving when viewed from the own car. However, the road and car ahead differ in behavior and velocity, and therefore it is possible to focus the area in which the car is possibly running by paying attention to this difference in movement. In this case, the accuracy of focusing is improved.

The area detected in this way is expressed with a rectangle and the coordinates of those vertices are used as the area information. As in the case of the method above, it is possible to regulate the size of the area to be detected and size of the flow to be extracted using regulation circuit 160.

It is also possible to focus the search range using a stereoscopic image. Detection of a vehicle area using a stereoscopic image is disclosed, for example, in the paper “Development of Object Detection Method using Stereo Images” (Kigasawa, et al., Collected Papers of 2nd Symposium on Sensing via Image Information (SII′96), pp.259-264). This method performs focusing by recognizing a three-dimensional shape, and therefore provides accurate focusing.

The area detected in this way is expressed with a rectangle and the coordinates of those vertices are used as the area information. It is possible to regulate the height, etc. of an object to be detected using regulation circuit 160.

It is also possible to use a combination of an optical flow and stereoscopic images. That is, it is also possible to calculate a sum of sets of the area detected by the optical flow method and the area detected using stereoscopic images or calculate a product of sets thereof to determine the area to which image processing is applied.

This makes it possible to detect the area of a stationary vehicle, which cannot be detected by the use of the optical flow alone.

This method also eliminates building structures on the road that are unnecessarily detected by the use of stereoscopic images alone. In this way, synergistic effects can be expected. In this case, it is also possible to adjust the method and ratio of combination by regulation circuit 160.

Next, the detection operation of the position of the vehicle in the image by vehicle position detection section 140 will be explained.

Vehicle position detection section 140 functions to detect the accurate position of the vehicle in the search range determined by the area information sent from search range extraction section 130 and send the result to inter-vehicle distance calculation section 150 as position information.

There are various techniques to identify the position of the vehicle in the image.

For example, the method of determining the similarity to a registered model provides high detection accuracy, and therefore is a desirable method.

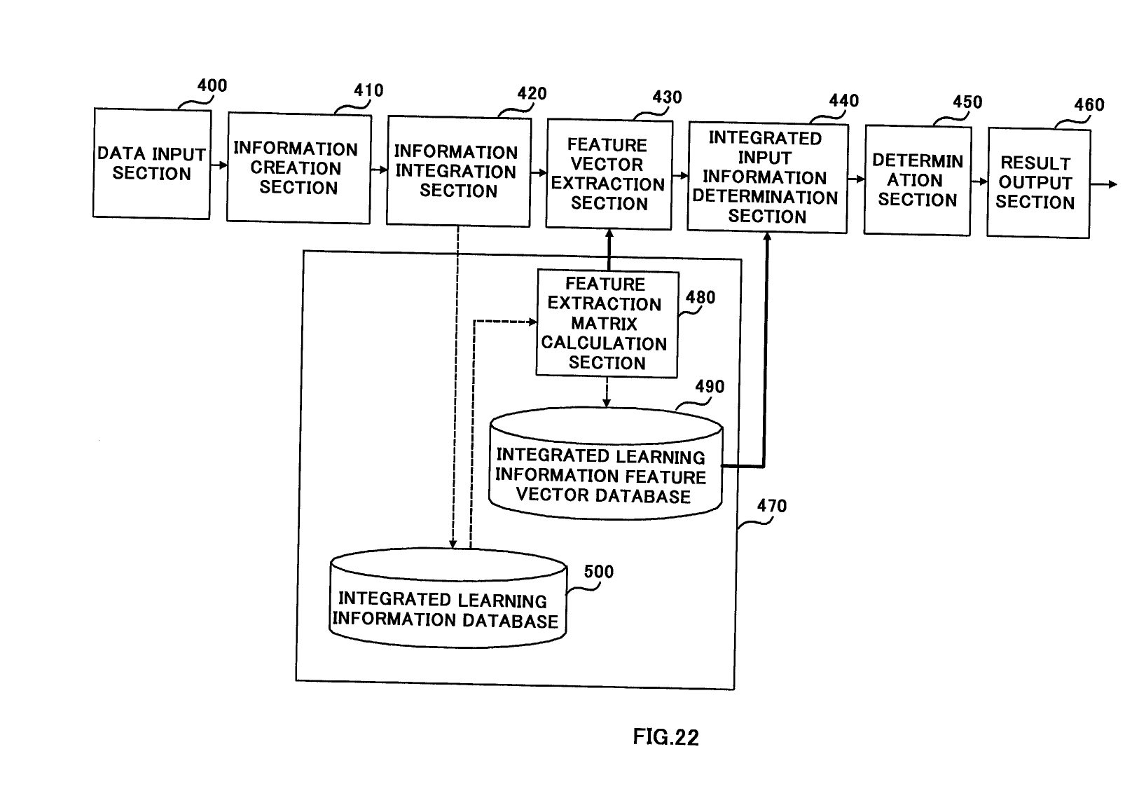

This method uses a pattern recognition technology and FIG. 22 shows a block configuration of the apparatus to implement this system.

In the figure, reference numeral 470 is learning means and reference numeral 500 is an integrated learning information database.

In this integrated learning information database 500, vehicle models are classified into different classes and the results are stored as integrated learning information.

On the other hand, feature extraction matrix calculation section 480 calculates such a feature extraction matrix that makes each class most organized and separates one class from another most.

Integrated learning information feature vector database 490 stores an average per class of the integrated learning information feature vectors calculated using the feature extraction matrix.

The arrowed dotted lines in FIG. 22 indicate the procedure in the learning stage.

In such a condition, image data within the search range is input from data input section 400. Information creation section 410 extracts information of part of the input image and crates a one-dimensional vector. Information integration section 420 simply links the created information pieces.

Feature vector extraction section 430 extracts feature vectors using the feature matrix calculated by learning section 470.

Input integrated information determination section 440 compares the extracted feature vectors and the feature vectors output from integrated learning information feature vector database 490 and calculates the similarity.

Determination section 450 determines the input integrated information (and the class thereof) with the greatest similarity value from among the similarity values input from input integrated information determination section 440.

That is, determination section 450 determines the position of the pattern determined to have the greatest similarity as the information of the position of the vehicle. The determination result is output from result output section 460.

The method of determining the position of the vehicle in the image is not limited to this and there is also a method of using the edges of the vehicle.

An example of position detection using edges of a vehicle is disclosed in the Japanese laid open patent application No.HEI8-94320 (“Mobile Object Measuring Apparatus”), for example. The position detected in this way is used as position information.

Then, the method of calculating the distance between cars in the real space will be explained.

Inter-vehicle distance calculation section 150 in FIG. 18 calculates the distance to the vehicle in the real space based on the position information determined by vehicle position detection section 140 and outputs the calculated distance as the measurement result. A more specific example of the system of calculating the distance between cars is shown below.

A first system uses stereoscopic images. The distance is calculated by determining parts (e.g., number plate (reference numeral 34 in FIG. 3)) suited to calculating the distance based on the detected position of the vehicle and determining the corresponding position in a stereoscopic image and this is used as the measurement result.

A second system is the one that calculates the distance using a road structure according to a plan view. This method is effective in the sense that it has the ability to effectively use information of the actual shape of the road, provides a relatively easy calculation method and high measuring accuracy.

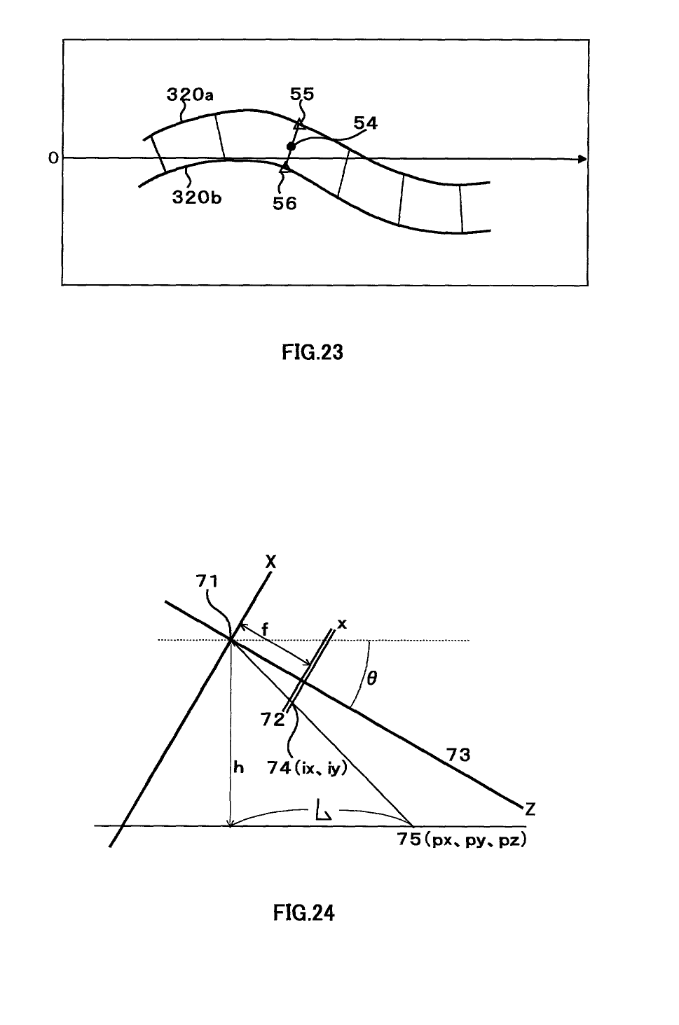

That is, as shown in FIG. 23, white lines 320a and 320b in the image are detected and the road structure in the real space is reconstructed based on this. As explained before, an example of the reconstruction method is disclosed, for example, in the paper “Reconstructing Road Shape by Local Plane Approximation” (Watanabe et al., Technical report of Information Processing Society of Japan CV62-3) (FIG. 7A to FIG. 7C).

Then, the positions of the right and left white lines (reference numerals 56 and 55) corresponding to the detected positions of the vehicle are determined, the distance is calculated by detecting the position in the real space based on the reconstruction of the road structure from these positions and this is used as the measurement result.

A third system uses laser rader 111 in FIG. 18. First, pictures of a front view are taken by one or two cameras and the position of the vehicle is detected. Then, parts (e.g., number plate) suited to calculating the distance based on the detected position of the vehicle are determined. Then, the distance to the position is calculated using laser radar 111 and this is used as the measurement result. Distance measurement using the laser radar improves the accuracy of measurement.

A fourth system uses an assumption that the road is horizontal between the own car and the vehicle to be detected. As shown in FIG. 24, assuming that the camera parameters (focal distance f, height of the center of the lens h and angle that the optical axis of the camera makes with the horizontal direction) are known and the detected position of the vehicle is (ix, iy), coordinate point 75 is determined from aforementioned (mathematical expression 1). Once the position of this coordinate point is found, distance L can be calculated. This is used as the measurement result.

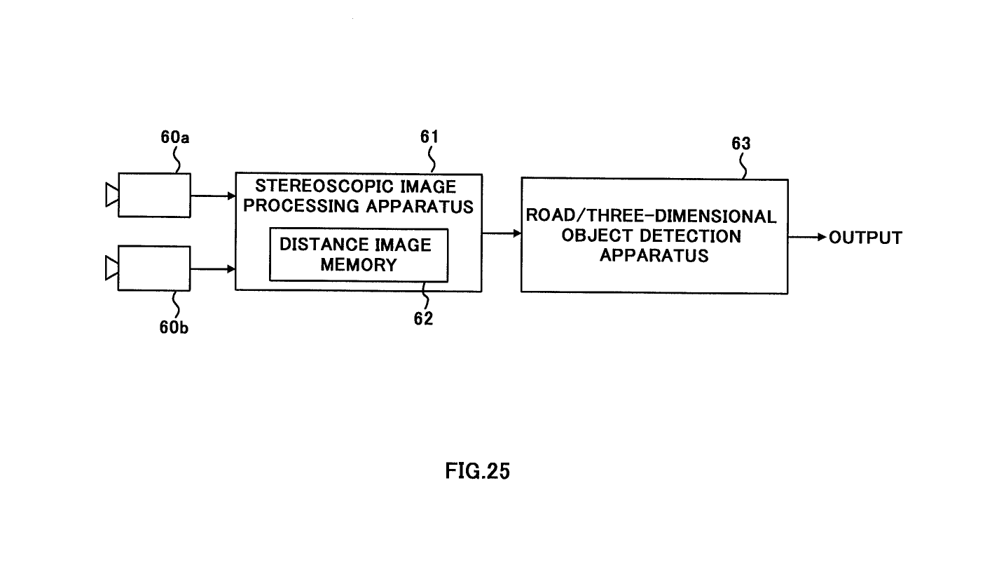

This embodiment focuses the range of applying image processing. This contributes to reduction of the capacity of memory 62 that stores distance images when stereoscopic pictures are taken using two cameras as shown in FIG. 25.

As explained above, since this embodiment focuses the range of applying image processing, it is possible to detect vehicles efficiently and accurately and calculate distances between cars accurately.

This embodiment also has an effect of contributing to reduction of burden on the hardware of the apparatus and reduction of processing time.

The present invention is not limited to the above described embodiments, and various variations and modifications may be possible without departing from the scope of the present invention.

This application is based on the Japanese Patent Application No. HEI11-290685 filed on Oct. 13, 1999, and Japanese Patent Application No. HEI11-298100 filed on Oct. 20, 1999, entire content of which is expressly incorporated by reference herein.

What is claimed is:

1. A distance measuring method comprising:
a first step of detecting an object that exists at the edges of a road or on the road from an image input from one camera, detecting the detected position of said object in said image and detecting a relative positional relation between said object and said edges of the road;
a second step of detecting a three-dimensional road structure from said image;
a third step of determining the position of said object on said three-dimensional road structure based on a relative positional relation between the object in said image and the road edges; and
a fourth step of calculating the distance from said one camera to said object in the real space.

2. The distance measuring method according to claim 1, wherein said first step comprising the steps of:
detecting a target object from images taken by one camera;
designating a representative point of the detected object as a coordinate point indicating the position of the object;
detecting a shortest line segment from among the line segments that pass said coordinate point of the object and connect the right and left edges of the road in said image;
detecting edge points at which said detected line segment crosses the right and left edges of the road; and
determining the position of said coordinate point of the object on said detected line segment, and
said third step comprising the steps of:
detecting two points corresponding to said edge points on the reconstructed road structure; and
determining a coordinate point corresponding to said coordinate point of the object on said detected line segment connecting the two points, that is, the coordinate point of the object in the real space.

3. The distance measuring method according to claim 1, wherein the processing in said first step of detecting an object that exists on said road comprising the steps of:
extracting the amount of features of the object from said image; and
comparing said extracted amount of features and the amount of features of a plurality of learning images registered beforehand, determining the learning image most resembling said features of the object and thereby detecting that an object identical to the learning image exists on said road.

4. The distance measuring method according to claim 3, wherein said amount of features of the object is expressed by at least one of the length of each of a plurality of straight lines extracted from a differential binary image of the object, symmetry of each straight line and positional relation of each straight line.

5. The distance measuring method according to claim 1, wherein the processing in said first step of detecting the detected position of said object in the image comprises a step of comparing said image and a plurality of learning images registered beforehand, determining the area most resembling at least one of said plurality of learning images and determining the determined area as the area in which an object identical to the object of the learning image exists.

6. The distance measuring method according to claim 5, wherein said plurality of learning images includes a plurality of images obtained by taking pictures of one object at different distances.

7. The distance measuring method according to claim 1, wherein said second step of detecting a three-dimensional road structure from said image comprising the steps of:
detecting the positions of the corresponding right and left road edge points in said image; and
determining the positions of the road edge points in the real space corresponding to said right and left road edge points in said image and detecting the three-dimensional structure of the road from the loci of the road edge points in the real space.

8. A distance measuring method comprising:
a first step of detecting an object that exists at the edges of a road or on the road from images input from one camera that consecutively takes pictures in the direction opposite to the direction in which the car is headed, detecting the position of said detected object in said image and detecting a relative positional relation between said object and said edges of the road;
a second step of detecting a three-dimensional road structure from said image;
a third step of determining the position of said object on said three-dimensional road structure based on a relative positional relation between the object in said image taken by said one camera and the road edges; and
a fourth step of calculating the distance from said one camera to said object in the real space,
wherein said second step comprising the steps of:
assuming that the road is horizontal at locations sufficiently close to said one camera, measuring the distance from said one camera to road edges located within the range sufficiently close to the camera and thereby detecting the positions of the road edge points in the image, determining the positions of the road edge points in the real space corresponding to the detected road edge points and continuing such processing, and
on the other hand, acquiring information on the amount of movement of the own car in the real space from a past reference time point to the present moment from a sensor mounted on the own car, connecting the road edge points in the real space corresponding to said past reference time point and the road edge points in the real space corresponding to said present moment based on said information of the amount of movement acquired from said sensor, repeating such connection processing and thereby reconstructing a three-dimensional road structure.

9. A distance measuring apparatus comprising:
an object position detection section that detects an object that exists at the edges of a road or on the road from an image input from one camera, detects the position of the detected position of said object in said image and detects a relative positional relation between said object and said edges of the road;
a road structure detection section that detects a three-dimensional road structure from said image; and
a distance calculation section that determines the position of said object on said three-dimensional road structure based on a relative positional relation between the object in said image and the road edges and calculates the distance from said one camera to said object in the real space.

10. A distance measuring method comprising the steps of:
focusing the range of searching an object based on an image input from a car-mounted camera on an area in which said object is likely to exist;
detecting the position of said object in said image within said search range; and
calculating the distance to said vehicle in the real space based on the detected position of said object.

11. A distance measuring method comprising the steps of:
detecting the right and left edges of a road on which an object exists based on an image input from a car-mounted camera and focusing the range of searching the object taking into account the detected positions of the road edges and height of said object;
detecting the position of said object in said image within said focused search range; and
calculating the distance to said vehicle in the real space based on the detected position of said object.

12. The distance measuring method according to claim 11, wherein the area of a rectangle is determined taking into account the positions of said right and left road edges and the height of said object and the coordinates of the vertices in the rectangular area are used as the information to determine the search range.

13. The distance measuring method according to claim 11, wherein when the search range is focused, the degree of focusing of the search range can be regulated by specifying parameters.

14. The distance measuring method according to claim 11, wherein the area on the road in which an object exists is determined using an optical flow method and the area is used as the search range.

15. The distance measuring method according to claim 11, wherein the area on the road plane in which a vehicle exists is determined using stereoscopic images and this area is used as the search range.

16. The distance measuring method according to claim 11, wherein a combination of the area on the road in which a mobile object exists determined using an optical flow method and the area on the road in which the object exists determined using stereoscopic images is used as the search range.

17. The distance measuring method according to claim 11, wherein the processing of detecting the position of the object in the image includes a step of comparing said image and a plurality of learning images registered beforehand, determining the area most resembling said at least one of said plurality of learning images in said image and thereby determining the determined area as the area in which an object identical to the object of the learning image exists.

18. The distance measuring method according to claim 11, wherein the distance to the vehicle in the real space is determined using stereoscopic images based on the position of the detected object.

19. The distance measuring method according to claim 11, wherein the distance to the vehicle in the real space is determined using the detected position of the vehicle in the image and the one-dimensional shape of the road.

20. The distance measuring method according to claim 11, wherein the distance to the vehicle in the real space is determined using laser radar based on the detected position of the vehicle in the image.

21. A distance measuring apparatus comprising:
a search range extraction section that focuses the search range on the area on a road in which an object exists from an image input from a car-mounted camera;
a vehicle position detection section that detects the position of the object in the image within said search range; and
an inter-vehicle distance calculation section that calculates the distance to the vehicle in the real space based on said detected position.

22. The distance measuring apparatus according to claim 21, wherein said search range extraction section comprises a regulation section to regulate the degree of focusing of the search range according to parameter specification.

23. The distance measuring apparatus according to claim 21, wherein said inter-vehicle distance calculation section compares said image and a plurality of learning images registered beforehand, determines the area most resembling at least one of said plurality of learning images and determines the determined area as the area in which an object identical to the object of the learning image exists.
